(19) United States
(12) Patent Application Publication
(10) Pub. No.: US 2025/0050425 A1
(43) Pub. Date: Feb. 13, 2025

(54) TOOL POST COMPRISING A PLURALITY OF TOOL-HOLDER SPINDLES AND NUMERICALLY-CONTROLLED MACHINE TOOL INCLUDING SUCH A TOOL POST

(71) Applicant: ETA SA Manufacture Horlogère Suisse, Grenchen (CH)

(72) Inventors: Patric PHAM, Utzenstorf (CH); Christophe DONZÉ, Pieterlen (CH)

(73) Assignee: ETA SA Manufacture Horlogère Suisse, Grenchen (CH)

(21) Appl. No.: 18/672,086

(22) Filed: May 23, 2024

(30) Foreign Application Priority Data
Aug. 11, 2023 (EP) 23191122.3

(51) Int. Cl. B23B 13/04; B23Q 15/013

(52) U.S. Cl. CPC B23B 13/04; B23Q 15/013; B23Q 2220/006

(57) ABSTRACT

A tool post including a body extending according to an axis A-A, the latter including, at one of its ends, a base for fastening to a numerically-controlled machine tool and, at the other end, a head movable in rotation, the head including at least two tool-holder spindles, each being intended to receive a cutting tool in engagement, the spindles occupying, depending on the angular position of the head, a working position in which they are intended to carry out a machining operation on a workpiece held in position in a fitting or a standby position in which they are withdrawn from the workpiece, each of the spindles being configured to be controlled independently of the other in order to immobilise or drive in rotation the cutting tool carried thereby, irrespective of the position it occupies.

### TECHNICAL FIELD OF THE INVENTION

The invention relates to the field of numerically-controlled machine tools for machining parts, preferably micromechanical parts, and to the field of equipment for such machines.

More particularly, the invention relates to a tool post comprising a plurality of tool-holder spindles and a numerically-controlled machine tool including such a tool post.

### Technological Background

Numerically-controlled machine tools are intended to produce mass-produced parts, in particular by machining, following the instructions of a computer program. These machines include a tool mounted in a tool-holder spindle and are generally equipped with a tool changer to change the tool held by the tool-holder spindle to adapt it to the machining operations to be carried out on the part held in position in a fitting.

When a tool is changed, the machine tool is no longer productive meaning that the machining operations are interrupted. Hence, the aim is to minimise tool change times. To this end, tool changers have been developed to work in masked time as much as possible and minimise machine tool downtime to increase productivity thereof.

For example, multi-spindle tool posts are known comprising a head on which several tool-holder spindles are arranged, one of which is active and the others are at rest. In particular, the active tool-holder spindle is engaged with a drive mechanism thanks to a coupling system. Thus, between two machining operations, the tool can be changed by uncoupling the active tool-holder spindle, i.e. that one carrying the tool to be changed, rotating the head so as to present the next tool-holder spindle and coupling this tool-holder spindle to the drive mechanism.

Nonetheless, this solution is not entirely satisfactory in that, although tool change times are reduced, they are not entirely masked. Indeed, between each tool change, with this type of multi-spindle tool post, it is necessary to brake the tool to be changed before carrying out the tool change and to accelerate the next tool once it is coupled to the drive mechanism, until it reaches its machining rotational speed. These multi-spindle tool posts also require a certain amount of time to uncouple the tool to be changed, rotate the head and index the next tool to align it with the coupling system, and then carry out the coupling. This solution is also particularly complex and expensive because of the coupling system.

The are multi-spindle tool posts addressing the problem of tool-holder spindle acceleration and braking, wherein all tools are driven in rotation, synchronously. Thus, when the tool is changed, the next tool is already driven at its machining speed and can start machining the part. However, these multi-spindle tool posts require large amounts of energy to rotate all tools simultaneously. Moreover, the maximum rotational speed of the tools carried thereby is relatively limited due to the motion transmission kinematic chain.

Overall, whether they rotate the tools they carry individually or simultaneously, the multi-spindle tool posts in the state of the art are bulky, which generates high moments of inertia and increases the risk of collision between the fitting and the tools carried by the tool post.

In addition to the aforementioned drawbacks, these solutions are not suitable for machining micromechanical parts.

### SUMMARY OF THE INVENTION

The invention resolves the aforementioned drawbacks by offering a solution allowing completely masking tool change times, in particular by masking the tool acceleration and deceleration phases. Another objective achieved by the invention is to maximise the compactness of the machine tool and reduce the moving masses.

To this end, the present invention relates to a tool post comprising a body extending according to an axis A-A, the latter comprising, at one of its ends, a base for fastening to a numerically-controlled machine tool and, at the other end, a rotatably movable head. The head includes at least two tool-holder spindles, each being intended to receive a cutting tool in engagement. Depending on the angular position of the head, the spindles occupy a working position in which they are intended to carry out a machining operation on a workpiece held in position in a fitting, or a standby position in which they are withdrawn from the workpiece. Each of said spindles being configured to be controlled independently of the other in order to immobilise or drive in rotation the cutting tool carried thereby, irrespective of the position it occupies.

As the spindles are servo-controlled independently, it is possible to accelerate and decelerate the spindles in masked time. Hence, the present invention allows carrying out a tool change with a dead time reduced only to the duration of the rotation of the head until the next tool comes into contact with the workpiece. Thanks to the features of the invention, the tool change time, chip to chip, is estimated to be in the range of a few tenths of a second.

The invention also has the advantage of being adaptable to any existing machine tool.

Also, thanks to the invention, the spindles can reach relatively high rotational speeds, for example in the range of 60,000 to 80,000 revolutions per minute.

In particular embodiments, the invention may further include one or more of the following features, considered separately or in any technically-feasible combination.

In particular embodiments, the axis of rotation of the head coincides with the axis A-A.

In particular embodiments, the base is configured so that the axis A-A forms an angle comprised between 35 and 55 degrees with respect to a vertical axis.

These features participate in maximising the compactness of the device.

In particular embodiments, the spindles are distributed around the axis of rotation of the head, preferably evenly, each spindle being arranged so that its axis B-B, B-B′ and B-B″ forms an angle comprised between 35 and 55 degrees with respect to the axis A-A and so that their axes B-B, B-B′ and B-B″ are not intersecting.

On the one hand, this feature makes it easier to clear the tools when they are at rest in order to avoid or limit the risk of collisions with the fitting and, on the other hand, enables all the spindles to maintain the same working position, thereby helping ensure that machining tolerances are met.

In particular embodiments, the spindles are arranged with respect to each other so that the projection of their longitudinal axes B-B, B-B′ and B-B″ in a plane P orthogonal to the axis A-A forms an n-order regular polygon centred on the axis A-A, where n is the number of spindles.

In particular embodiments, the spindles are arranged so that their longitudinal axes B-B, B-B′ and B-B″ are separated from the axis A-A by a distance larger than the radius of a spindle.

This feature also participates in clearing the tools when they are at rest, in order to avoid or limit the risk of collisions with the fitting.

In particular embodiments, each of the spindles comprises its own motor for rotating or immobilising the cutting tool carried thereby.

This feature allows reducing the energy consumption of the tool post, as the spindles that are not carrying out machining operations are immobile in rotation about their respective longitudinal axes.

In particular embodiments, at least one spindle is adapted to occupy at least two distinct working positions, each of which is defined by a predefined angular position of the head of the tool post.

In particular embodiments, at least one spindle is adapted to occupy a working position continuously as the head of the tool post rotates. This arrangement also involves a continuous movement of the fitting.

According to another object, the present invention relates to a numerically-controlled machine tool preferably for machining micromechanical parts, comprising at least one tool post as described before, fastened by the base directly to a frame or to a carriage movable in translation in a vertical plane, so that the axis A-A forms an angle comprised between 35 and 55 degrees with respect to a vertical axis, said machine tool further comprising a fitting intended to hold a part to be machined in position.

In particular embodiments, the machine tool includes two tool posts arranged on either side of the fitting.

In particular embodiments, the machine tool comprises protective walls against splashing chips and cutting fluid, the body of the or each tool post being engaged in a respective opening of said protective wall(s) in a liquid-tight manner.

Yet another aspect of the invention relates to a method of changing the tool of a machine tool as described before, wherein:
a first cutting tool engaged in a spindle in the working position carries out a first machining phase and a second cutting tool engaged in a spindle in the standby position is intended to carry out a second machining phase and is prevented from rotating;
before the end of the first machining phase, the second cutting tool is rotated about its B-B′ axis until reaching a rotational speed specific to the second machining phase;
once the first machining phase has been completed, the head is pivoted about the axis A-A so as to drive the spindle carrying the second cutting tool into the working position so that the latter can begin the second machining phase, and so as to drive the spindle carrying the first cutting tool into the standby position, the latter being prevented from rotating once the spindle carrying it has reached its standby position.

### BRIEF DESCRIPTION OF THE FIGURES

Other features and advantages of the invention will become apparent upon reading the following detailed description, given as a non-limiting example, with reference to the appended drawings wherein:

FIG. 1 shows a perspective view of a multi-spindle tool post according to a preferred embodiment of the invention;

FIG. 2 shows a view of the tool post of FIG. 1, oriented according to the longitudinal axis of the body of the tool post;

FIG. 3 shows a side view of the tool post of FIG. 1;

FIG. 4 shows a perspective view of two tool posts arranged on either side of a workpiece fitting.

It should be noted that the figures are not necessarily drawn to scale for clarity.

### DETAILED DESCRIPTION OF THE INVENTION

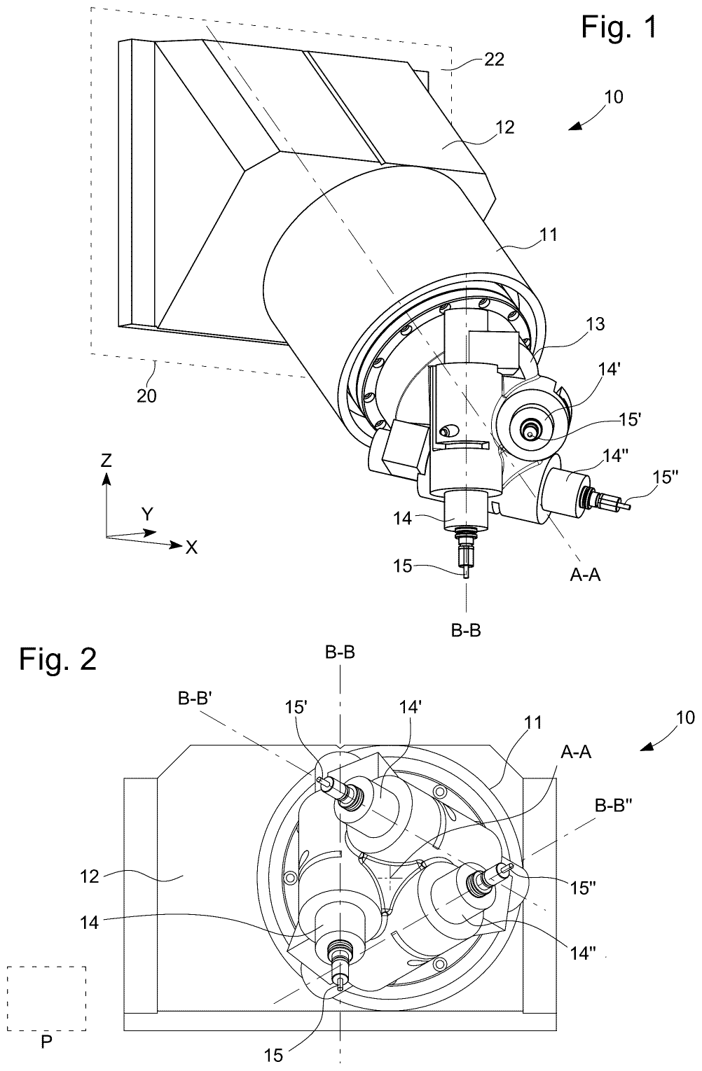

FIG. 1 shows a tool post 10 intended for machining parts, preferably micromechanical parts. The tool post 10 comprises a body 11 extending according to a longitudinal axis denoted the “A-A axis”, comprising at one of its ends a base 12 for fastening to a numerically-controlled machine tool 20 and at the other end a head 13 movable in rotation about an axis coincident with the A-A axis, in the embodiment of the invention. The head 13 has at least two tool-holder spindles 14, 14′ or 14″, each intended to receive in engagement a cutting tool 15, 15′ or 15″. Depending on the angular position of the head 13, each spindle 14, 14′ and 14″ occupies a working position, in which it is intended to carry out a machining operation on a workpiece held in position in a fitting 21, or a standby position, in which it is withdrawn from the workpiece.

It should be noted that the tool post 10 can be driven in translation, for example if the base 12 is fastened to a carriage of the machine tool 20 (not shown in the figures) movable according to at least one degree of freedom in translation, preferably according to three degrees of freedom in translation with reference to an XYZ trihedron.

Alternatively, the tool post 10 can be immobile, for example if the base 12 is fastened directly to a frame 22 of the machine tool 20.

Advantageously, the spindles 14, 14′ and 14″ are configured so as to be controlled independently of each other in order to rotate or immobilise the cutting tool 15, 15′ or 15″ carried thereby. This feature is particularly advantageous when changing tools. Preferably, the spindles 14, 14′ and 14″ are motorised-type spindles, also known as “electro-spindles”, and each comprises its own motor for rotating or immobilising the cutting tool 15, 15′ or 15″ carried thereby.

In particular, in order to change a first cutting tool 15 carrying out a first machining phase, for a second cutting tool 15′ intended to carry out a second machining phase, the latter is rotated, before the end of the first machining phase, until it reaches a rotational speed specific to the second machining phase.

The first cutting tool 15 is engaged in a spindle 14 in the working position and the second cutting tool 15′ is engaged in a spindle 14′ in the standby position.

Once the first machining phase has been completed, the head 13 is pivoted so as to drive the spindle 14, which was in the working position, into the standby position, and so as to drive the spindle 14′, which was in the standby position, into the working position. The second machining phase then begins immediately, thanks to the fact that the second cutting tool 15′ has reached its machining rotational speed when the spindle 14′ in which it is engaged was in the standby position. The spindle 14 carrying the first cutting tool 15 now in the standby position, the latter is the immobilised.

Thus, as the second cutting tool 15′ is rotated and the first cutting tool 15 has stopped rotating in hidden time, the cutting tool is changed with a dead time reduced only to the duration of the head rotation.

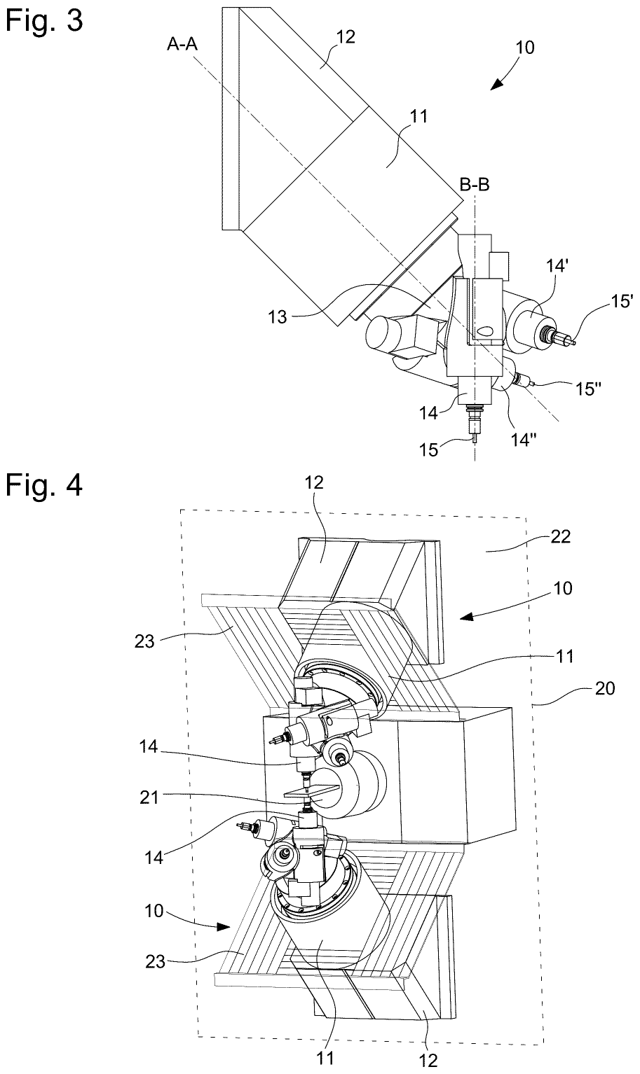

Each spindle 14, 14′ and 14″ extends respectively according to a longitudinal axis denoted the “B-B axis”, “B-B′ axis” and “B-B” axis”, also forming their axis of rotation, this axis being shown only on the spindle 14 in the working position in FIGS. 1 and 3. As shown in these figures, in the working position, the spindle 14 is oriented so that its axis B-B is parallel to a vertical axis. However, it is also possible that, in another working position, spindle 14 is oriented so that its axis B-B is parallel to a horizontal axis. The spindle 14 may also occupy a dynamic working position, i.e. the head 13 may be rotated during the machining operation. In this case, the fitting 21 may be movable and moved according to instructions related to a machining program, and/or the tool post 10, via its base 12, may be movable and moved according to instructions related to the machining program.

In the preferred embodiment of the invention, and as shown in the figures, the tool post 10 includes three spindles 14, 14′ and 14”. In FIG. 2, which specifically shows the distribution of the spindles 14, 14′ and 14″ on the head 13 of the tool post 10, the spindles 14, 14′ and 14″ are evenly distributed around the axis of rotation of the head 13, i.e. in the embodiment of the invention, around the axis A-A. The spindles 14, 14′ and 14″ are arranged relative to each other so that the projection of their axes B-B, B-B′ and B-B″ in a plane P orthogonal to the axis A-A forms an n-order regular polygon centred on the axis A-A, where n is the number of spindles. In the example shown in FIG. 2, the longitudinal axes of the spindles 14, 14′ and 14″ form an equilateral triangle.

Moreover, in the preferred embodiment of the invention, the spindles 14, 14′ and 14″ are arranged so that their axes B-B, B-B′ and B-B″ are separated from the axis A-A by a distance larger than the radius of a spindle 14, 14′ or 14″, for example corresponding to at least the diameter of a spindle 14, 14′ or 14″. This arrangement allows maximising the clearance of the cutting tools 15′ or 15″ from the spindles 14′ and 14″ in the standby position, and thus avoiding the risk of collisions between these cutting tools 15′ and 15″ and the fitting 21 or the workpiece. It should be noted that, in general, the greater the number of spindles the head includes, the larger the distance separating the axis A-A from the axes B-B, B-B′ and B-B″ of the spindles.

Furthermore, as shown in particular in FIG. 3, the tool post 10 is configured so that the A-A axis forms an angle comprised between 35 and 55 degrees, preferably 45 degrees, with respect to a vertical axis thanks to the conformation of the base 12. Consequently, the spindles 14, 14′ and 14″ are arranged on the head 13 so that their axes B-B, B-B′ and B-B″ are inclined with respect to the axis A-A at an angle comprised between 35 and 55 degrees, preferably 45 degrees, so that, in their working position, they are parallel with a vertical axis, as described before.

Overall, as can be deduced from the foregoing and from the figures, the spindles 14, 14′ and 14″ are arranged symmetrically with respect to each other according to the axis A-A and the axes B-B, B-B′ and B-B″ of the spindles 14, 14′ and 14″ do not intersect each other.

Furthermore, the particular arrangement of the spindles 14, 14′ and 14″ with respect to the head 13 of the tool post 10 allows reducing the force loop. Indeed, the spindles 14, 14′ and 14″ are fastened as close as possible to the connecting element, formed for example by a ball bearing, enabling the head 13 to pivot relative to the body 11 of the tool post 10.

Moreover, the machine tool 20 can include two tool posts 10 arranged on either side of the fitting 21, as shown in FIG. 4. As shown in this figure, thanks to the two tool posts 10, it is possible to carry out two machining operations simultaneously on the same workpiece. Advantageously, the axes of rotation of the spindle 14 of each of the tool posts 10 in the working position may be coincident.

The fitting 21 may be in the form of a table designed to hold the workpiece in position and having varying degrees of translational and rotational mobility.

As shown in FIG. 4, the machine tool 20 may have protective walls 23 to protect against splashes of swarf and cutting fluid. In particular, a protective wall 23 is arranged in a liquid-tight manner around the body 11 of the or each tool post 10, and for this purpose comprises an opening through which said body 11 is engaged. The opening may include, on its periphery, a wiper seal arranged against said body 11. Furthermore, the protective wall 23 may advantageously comprise bellows. The wiper seal and the bellows allow preserving liquid-tightness during the movements of the tool post in the XYZ trihedron.

The protective wall 23 is fastened to the frame 22 of the machine tool 20 by its periphery.

Moreover, each protective wall 23 advantageously extends in a plane orthogonal to the axis A-A, i.e. in a plane inclined with respect to a horizontal axis, which allows promoting the flow of cutting fluid and swarf. This arrangement also makes it easier for an operator to access the fitting 21 and the spindles 14, 14′ or 14″.

More generally, it should be noted that the implementation and manufacturing methods considered hereinabove have been described as non-limiting examples, and that other variants are consequently conceivable.

1. A tool post comprising a body extending according to an axis A-A comprising at one of its ends a base for fastening to a numerically-controlled machine tool and at the other end a head movable in rotation, the head including at least two tool-holder spindles, each being intended to receive in engagement a cutting tool, the two tool-holder spindles occupy, depending on the angular position of the head, a working position to carry out a machining operation on a workpiece held in position in a fitting or a standby position in which the two tool-holder spindles are withdrawn from the workpiece, each spindle being configured so as to be controlled independently of the other in order to immobilise or drive in rotation the cutting tool carried thereby, irrespective of a position each spindle occupies.

2. The tool post according to claim 1, wherein an axis of rotation of the head is coincident with the axis A-A.

3. The tool post according to claim 2, wherein the base is configured so that the axis A-A forms an angle comprised between 35 and 55 degrees with respect to a vertical axis.

4. The tool post according to claim 1, wherein the two tool-holder spindles are distributed around an axis of rotation of the head, each spindle being arranged so that its axis B-B, B-B′ and B-B″ forms an angle comprised between 35 and 55 degrees with respect to the axis A-A and so that said axes B-B, B-B′ and B-B″ are not secant with each other.

5. The tool post according to claim 4, wherein the two tool-holder spindles are arranged relative to one another so that a projection of said axes B-B, B-B′ and B-B″ in a plane P orthogonal to the axis A-A forms an n-order regular polygon centred on the axis A-A, with n the number of spindles.

6. The tool post according to claim 1, wherein the two tool-holder spindles are arranged so that their axes B-B, B-B′ and B-B″ are separated from the axis A-A by a distance larger than the radius of a spindle.

7. The tool post according to claim 1, wherein each of the two tool-holder spindles comprises its own motor for rotating or immobilising the cutting tool carried thereby.

8. The tool post according to claim 1, wherein at least one spindle is adapted to occupy at least two distinct working positions, each of which is defined by a predefined angular position of the head of the tool post.

9. The tool post according to claim 1, wherein at least one spindle is adapted to occupy a working position continuously during rotation of the head of the tool post.

10. A numerically-controlled machine tool for machining micromechanical workpieces, comprising at least one tool post according to claim 1, fastened by the base directly to a frame or to a carriage movable in translation according to an XYZ trihedron, so that the axis A-A forms an angle comprised between 35 and 55 degrees with respect to a vertical axis, said machine tool further comprising a fitting intended to hold a workpiece to be machined in position.

11. The machine tool according to claim 10, including two tool posts arranged on either side of the fitting.

12. The machine tool according to claim 10, comprising protective walls against splashes of swarf and cutting fluid, the body of the or each tool post being engaged in a respective opening of said protective wall(s) in a liquid-tight manner.

13. A method for changing the tool of a machine tool according to claim 10, wherein:
a first cutting tool engaged in a spindle in the working position carries out a first machining phase and a second cutting tool engaged in a spindle in the standby position is intended to carry out a second machining phase and is prevented from rotating;
before the end of the first machining phase, the second cutting tool is rotated about its axis B-B′ until it reaches a rotational speed specific to the second machining phase;
once the first machining phase has been completed, the head is pivoted about the axis A-A so as to drive the spindle carrying the second cutting tool into the working position so that the latter starts the second machining phase, and so as to drive the spindle carrying the first cutting tool into the standby position, the latter being prevented from rotating once said spindle carrying it has reached its standby position.
